(19) United States
(12) Patent Application Publication
(10) Pub. No.: US 2003/0177982 A1
(43) Pub. Date: Sep. 25, 2003

(54) Marine eco-habitat system

(76) Inventor: Jeffrey D. Jenkins, Liberty Ville, IL (US)

Correspondence Address: JEFFREY D. JENKINS, 512 AMES STREET, LIBERTYVILLE, IL, 60048, US

(21) Appl. No.: 10/374,667

(22) Filed: Feb. 27, 2003

Related U.S. Application Data
(63) Continuation of application No. 10/101,932, filed on Mar. 21, 2002, now abandoned.

(51) Int. Cl. A01K 61/00

(52) U.S. Cl. 119/221

(57) ABSTRACT

An aquatic habitat made up of thin walled, symmetrically spaced plastic tubes vertically projecting from a thick walled base. The length of the tubes are pre-determined by the size of the base. Weep holes at the bottom of the tubes and between the tubes allow air to escape during installation into the marine environment. The vertical tubes, by design, act as a rudder to right the structure during its descent to the marine floor, thus allowing the installer to install the structure from above the waters surface.

### STATUS OF PATENT

Patent application Ser. No. 10/101,932 for the Marine Eco-Habitat System is currently under revision by the Inventor. Two prior office action summaries have been answered. Currently, this revision is to satisfy the attached office action of Patent Examiner Joan M. Oszewski. Statutory periods have been met as is this current revision.

### CROSS REFERENCE TO RELATED APPLICATIONS

| | | | |
|---|---|---|---|
| 3,898,958 | 8/1975 | Pranis,jr. | 119/3 |
| 4,061,110 | 12/1977 | Steidle | 119/4 |
| 4,165,711 | 8/1979 | Aoki | 119/3 |
| 4,244,323 | 1/1981 | Morimura | 119/3 |
| 4,266,509 | 5/1981 | Gollott et al. | 119/2 |
| 4,316,431 | 2/1982 | Kimura | 119/3 |
| 4,465,399 | 8/1984 | Kikuzawa et al. | 405/32 |
| 4,703,719 | 11/1987 | Mori | 119/3 |
| 4,736,708 | 4/1988 | Yoder | 119/2 |
| 4,913,094 | 4/1990 | Jones et al. | 119/3 |
| 4,947,791 | 8/1990 | Laier et al. | 119/3 |
| 5,038,715 | 8/1991 | Fahs, II | 119/3 |
| 5,109,796 | 5/1992 | Monus | 119/3 |

### STATEMENT REGARDING FED SPONSORED R & D

-N/A-

### APPENDIX

| | |
|---|---|
| Drawing (FIG. 1) | Cover |
| Descriptive Title of Invention | Page 1 |
| Related Applications | Page 1 |
| Appendix | Page 2 |
| Background of the Invention | Page 2 |
| Brief Summary of the Invention | Page 3 |
| Brief Description of the Drawing | Page 3 |
| Detailed Description | Page 3-4 |
| Abstract of the Disclosure | Page 5 |
| Claims | Page 6-8 |

### BACKGROUND OF THE INVENTION

1. Field of the Invention

This invention relates to aquatic habitats. In particular to this inventions multiple vertical tubes extending from a supporting base designed to rest submerged on the marine floor.

2. Prior Art

Many types if aquatic habitats have been suggested or proposed in prior art including U.S. Pat. Nos. 5,109,796; 5,038,715; 4,947,791; 4,913,094; 4,736,708; 4,703,719. Though all the habitats provide many various methods, shapes, materials and function, they all specifically have a restrictive water flow capability, which in turn allows siltation and damming of waterway debris, thus burying the prior art. Though any marine floor structure is susceptible to collective debris, this invention allows for the free flow of water past the vertical tubes thus improving on any prior habitat design.

### BRIEF SUMMARY OF THE INVENTION

The Marine Eco-Habitat System is manufactured into one unit. A plastic molded four-sided base containing two cross members has multiple vertical plastic tubes symmetrically spaced projecting perpendicular from the base structure. The plastic tubes are press fit into the fresh, hot molded base during the manufacture process, which creates a permanent bond once cooled.

### BRIEF DESCRIPTION OF THE DRAWING

Those having ordinary skills can best understand the Marine Eco-Habitat System by referring to FIGS. 1:

FIG. 1 is a three dimensional perspective of the invention.

### DETAILED DESCRIPTION

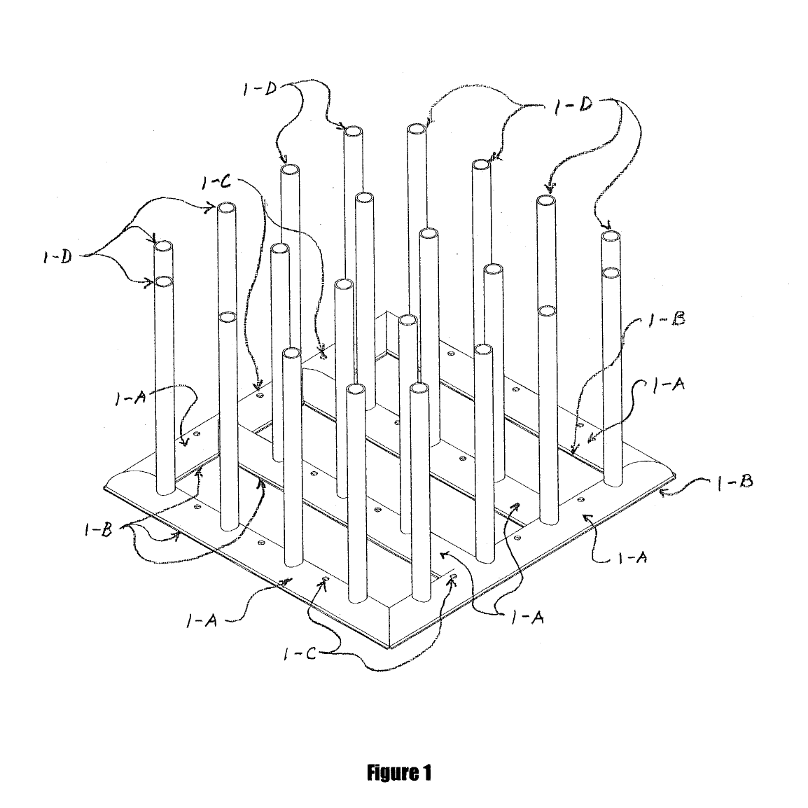

Throughout the following detailed descriptive please refer to the numeric drawings noted as FIG. 1.

The strength of the structure shown in FIG. 1 comes from the strength of the base. When this invention is manufactured in a small size, the base is molded and while fresh out of the mold, coupled to the symmetrically spaced vertical tubes. The purpose of the symmetrical spacing is for structural weight balance. The tubes are then pressed down into a deep socket, which has a vent hole in the bottom. The purpose of the vent hole is to allow air to escape from the top of the tube once the structure is eventually installed into a marine environment. Air freely flows out the top of the tubes as the structure slowly sinks under its own weight. Prior to total submersion, water squirts out of the top of the tubes, which begins a type of propulsion of water. Once totally submerged, the descent of the structure remains consistent and vertical due to the water flowing through the tubes thus assuring a flat landing on the marine floor. The size of the hole in the base structure at the vertical tube can be made small for a slow descent to the marine floor, or large for a fast descent. Weep holes, as shown between the vertical tubes, also allow air to escape from the base thus increasing the structures gravitational pull to the marine floor. The vertical tubes are generally thin walled while the base has thick walls making the unit bottom heavy, which assists in the proper descent to the marine floor. In a large structure size, all of the same factors exist except for the base structure. When building a 30′×30′ base, with 20′ vertical members automation is not as productive as a small structure, however the large structure is pieced together on site on a floating platform and again launched to its descent while instilling the integrity of the structure by design. The hollowed out half round base slows the structure during its descent while also is designed to minimize siltation, sedimentation and debris collection at the marine floor.

What is claimed is:

1) A marine ecological Habitat comprised of the following exact and specific reference parts:
A) The Base (1-A)
The base is molded of a one-piece PVC plastic continuous structure. A cross section of the typical base is designed with a half round shape having a 1″ inside radius. The thickness of the wall of the base is a ¼″, thus making the typical outside radius of the half round cross-section an 1¼″ radius. Due to the half round design along with the 1¼″″ outside radius, the outside typical total width of the typical base cross-section is exactly 2½″. The main structure and strength of each unit is the continuous perimeter of the base, which has an outside to outside, length and width, dimension of 30″ square. The additional strength of the structure is gained by having two cross members that run through the perimeter spaced 6⅔″ apart from the next cross member and the side perimeter. The cross members are additionally part of the one-piece molded base.
B) The Flange (1-B)
To further increase the strength of the continuous base, a ¼″ flange protrudes horizontally out from all lower edges of the continuous base. The additional purpose of the flange is to further anchor each unit to its marine environment through sedimentation build-up and, by design, a vacuum to the marine floor. With the additional ¼″ protrusion from all perimeter sides, the total finished outside to outside dimension of each unit is 30½″. Additionally the inside to inside cross-member spacing is 6⅙″ from side to side, and 24½″ in length.
C) Weep Holes (1-C)
In an effort to guarantee a steady, progressive, and safe landing on each units marine floor environment, weep holes are spaced proportionally across the continuous base to relieve the air pockets of all air during each units submersion. Weep holes are ¼″ in diameter and are located half way between each vertical pillar.
D) Vertical Pillars (1-D)
The vertical pillars are the most important part of each structures intended function, due to the excessive exposure of surface area to the marine environment, which promotes the growth of the food chain and the microorganisms. Each pillar is 19¾″ in height and have an inside diameter of 1″. The wall thickness of each pillar is a 1/16″ giving the total outside diameter of each pillar 1⅛″. During the manufacturing of the hot plastic molded base, the 22 vertical pillar parts are press fit into an 1⅛″ socket, in the hot mold, and then cooled to room temperature. The molded ¾″ deep socket that each vertical part is pressed into, has a ½″ hole at the bottom of the socket to additionally allow the air pockets to escape during each units descent to the marine floor. Water squirts vertically out of the vertical pillars once the continuous base is totally submerged, during each habitats installation. The squirting changes to excessive water flow, once totally submerged, which acts as propulsion and a rudder, thus, instilling a flat landing on the marine floor.
